(19) United States
(12) Patent Application Publication
(10) Pub. No.: US 2011/0176066 A1
(43) Pub. Date: Jul. 21, 2011

(54) PROJECTION SYSTEM AND METHOD

(75) Inventor: CHIEN-LIN CHEN, Tu-Cheng (TW)

(73) Assignee: HON HAI PRECISION INDUSTRY CO., LTD., Tu-Cheng (TW)

(21) Appl. No.: 12/823,144

(22) Filed: Jun. 25, 2010

(30) Foreign Application Priority Data
Jan. 20, 2010 (CN) 201010300449.1

(51) Int. Cl. H04N 9/31

(52) U.S. Cl. 348/744; 348/E09.025

(57) ABSTRACT

A projection system includes first and second cameras, a projector, and a processing unit. The first camera captures a first image of an object. The projector projects the first image and a selection symbol to a projection region. The second camera captures the projection region to obtain a second image of the projection region. The second image is detected to determine whether a selection controlling symbol is selected. If the selection controlling symbol is selected, a number of symbols corresponding to the selection symbol are transmitted to the projector. The symbols are projected in the projection region to form a number of controlling symbols. Another image of the projection region captured by the second camera is detected to determine whether one controlling symbol is selected. If one controlling symbol is selected, the processing unit controls the first camera, the second camera, or the projector accordingly.

### CROSS-REFERENCE TO RELATED APPLICATIONS

Relevant subject matter is disclosed in a co-pending U.S. patent application (Attorney Docket No. US31129) filed on the same date and having the same title, which is assigned to the same assignee as this patent application.

### BACKGROUND

1. Technical Field

The present disclosure relates to a projection system and a projection method.

2. Description of Related Art

Projectors are often used by teachers or presenters to project teaching material onto a screen. When the teacher wants to process the teaching materials, such as changing pages of the teaching materials, the teacher needs to return to the computer system to do so, or remain at the computer, unable to move around in the classroom, which is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic diagram of an exemplary embodiment of a projection system used in a classroom, the projection system including a storage unit.

FIG. 2 is a block diagram of the storage unit of FIG. 2.

FIGS. 3A-4D are schematic diagrams of operating the projection system of FIG. 1.

FIGS. 5A-5C is a flowchart of an exemplary embodiment of a projection method.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

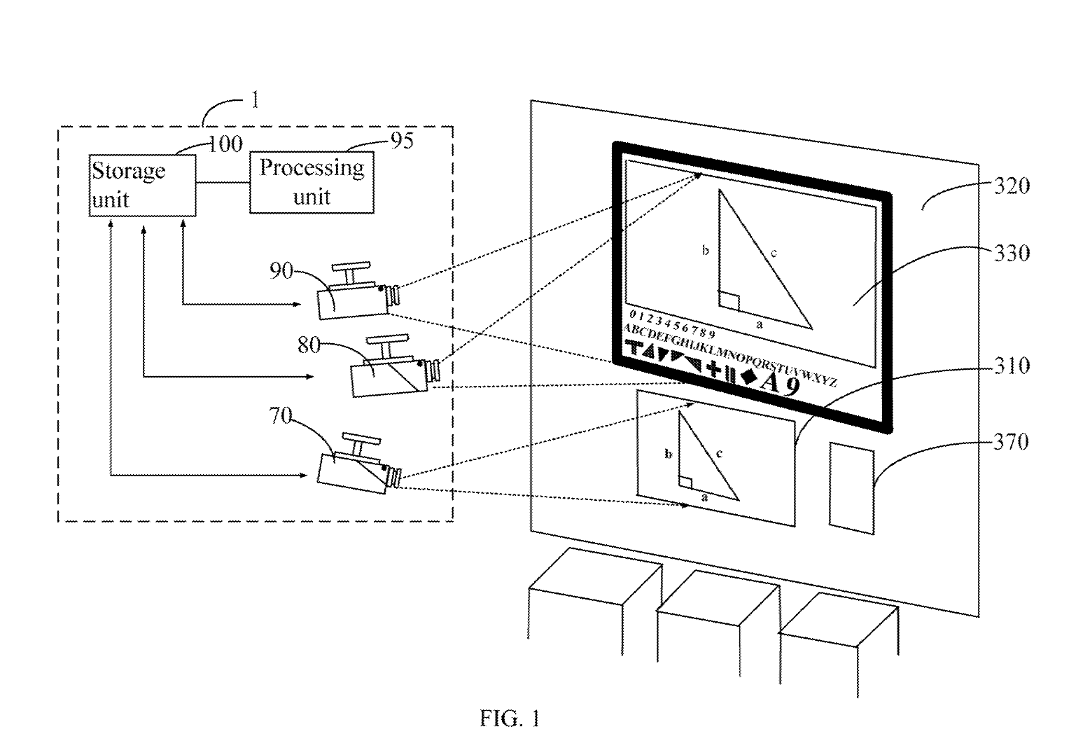

Referring to FIG. 1, an exemplary embodiment of a projection system 1 includes a first camera 70, a second camera 80, a projector 90, a storage unit 100, and a processing unit 95. The projection system 1 may be used in a group setting such as in a classroom.

The first camera 70 can be used to capture images of an object, which are then received by the projector 90 and projected on a projection region 330. The second camera 80 captures images of the projection region and transmits the images to the storage unit 100. The processing unit 95 accesses the images stored in the storage unit 100 and analyzes the image of the projection region 330 from the second camera 80 to determine whether any controlling symbols in the projection region 300 are selected. Upon the condition that the controlling symbol is selected, the processing unit 95 controls the first camera 70, the second camera 80, or the projector 90. In the embodiment, the first camera 70 and the second camera 80 are Pan/Tilt/Zoom (PTZ) cameras.

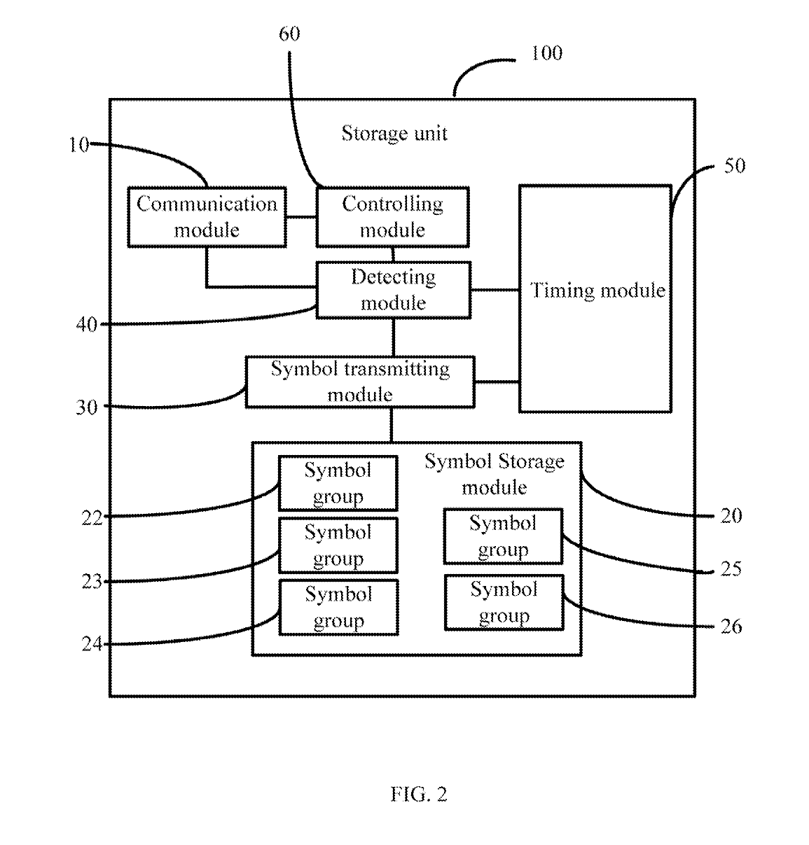

Referring to FIG. 2, the storage system 100 includes a communication module 10, a symbol transmitting module 30, a detecting module 40, a timing module 50, and a controlling module 60 which may include one or more computerized instructions and are executed by the processing unit 95, and a symbol storing module 20.

The communication module 10 transmits the images of the object from the first camera 70 to the projector 90. The projector 90 projects the images to the projection region 330. In addition, the communication module 10 further transmits the image of the projection region 330 from the second camera 80 to the detecting module 40.

The symbol storing module 20 stores a plurality of symbol groups, for example a first symbol group 22, a second symbol group 23, a third symbol group 24, a fourth symbol group 25, and a fifth symbol group 26. For instance, the first symbol group 22 includes two sets of pattern symbol units with same contents but different colors. Symbols in one of the two sets of pattern symbol units may be red, symbols in the other set of pattern symbol unit may be gray. The second symbol group 23 includes two sets of alphabetical selection symbols with same contents but different colors. One of the two alphabetical selection symbols may be red, the other first selection symbol may be gray. The third symbol group 24 includes two sets of alphabetical symbol units with same contents but different colors. Symbols in one of the two sets of alphabetical symbol units may be red, symbols in the other set of alphabetical symbol units may be gray. The fourth symbol group 25 includes two sets of numerical selection symbols with same contents but different colors. One of the two sets of numerical selection symbols may be red, the other set of numerical selection symbol may be gray. The fifth symbol group 26 includes two sets of numerical symbol units with same contents but different colors. Symbols in one of the two sets of numerical symbol units may be red, symbols in the other set of numerical symbol unit may be gray.

The symbol transmitting module 40 transmits one or more symbols from the symbol storage module 20 to the projector 90. The projector 90 further projects the one or more symbols to the projection region 330 to form a controlling region. The controlling region includes a plurality of controlling symbols. Each controlling symbol stands for a controlling action. For example, “+” represents: zoom in the projection of the object in the projection region 330. “M” represents: pan the lens of the first camera 70 left. “9” represents: switch the projector 90 from the first camera 70 to a computer system.

The detecting module 40 detects the images of the projection region 330 from the second camera 80, to determine whether one controlling symbol is selected. In the embodiment, the detecting module 40 determines whether one controlling symbol is hidden to know whether the controlling symbol is being selected. When the controlling symbol is not in the image, the controlling symbol is regarded as being hidden. The timing module 50 records the period or length of time the controlling symbol has been selected. If the length of time the controlling symbol has been selected is longer than a preset length of time, the detecting module 40 transmits a detection signal corresponding to the selected controlling symbol to the controlling module 60 or the symbol transmitting module 30.

The controlling module 60 controls the first camera 70, the second camera 80, or the projector 90 according to the detection signal from the detecting module 40. For example, when a detection signal corresponds to “+” is being selected, the controlling module 60 controls the lens of the first camera 70 to withdraw. As a result, an image of the object with a larger size is projected on the projection region 330. Furthermore, the controlling module 60 further controls the symbol transmitting module 30 to transmit different symbols to the projector 90 for displaying different controlling symbols in the projection region 330.

Referring to FIG. 1, a chalkboard 310 is in the classroom, and the chalkboard 300 is regarded as the object. The first camera 70 captures images of the chalkboard 310. The communication module 10 transmits the images of the chalkboard 310 to the projector 90. The projector 90 projects the images of the chalkboard 310 to the projection region 330. The projection region 330 is on a screen 320 in the classroom.

In the embodiment, the pattern symbols include “▴”, “▾”, [symbol] “+”, “−”, “♦”, “∥”, and “ [symbol] ”. The alphabetical selection symbol is “A”. The alphabetical symbols include “A” to “Z”. The numerical selection symbol is “9”. The numerical symbols include “0” to “9”. The numerical symbols are in the first row. The alphabetical symbols are in a second row below the first row. The pattern symbols, as well as the alphabetical selection symbol, and the numerical selection symbol are all in the third row below the second row.

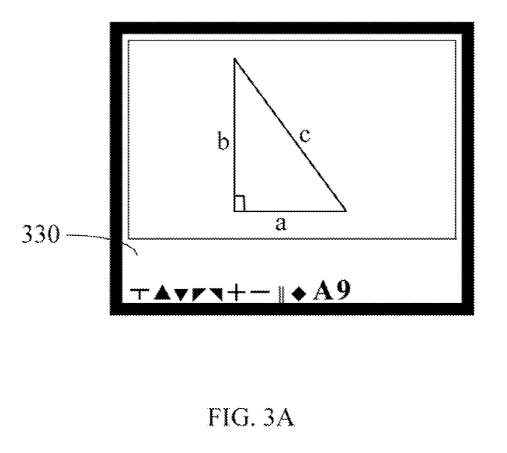

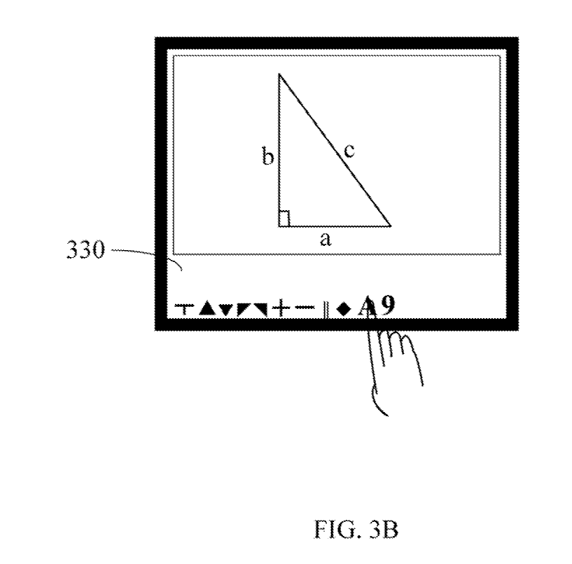

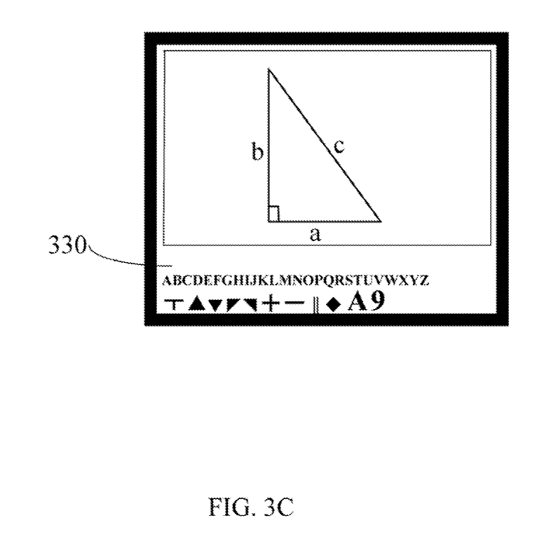

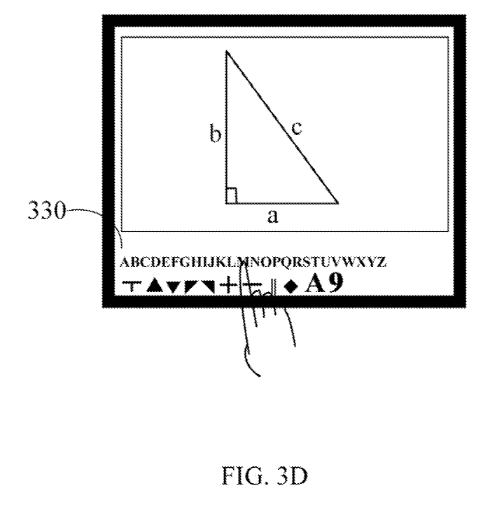

Referring to FIG. 3A, the symbol transmitting module 30 transmits the pattern symbols in red, the alphabetical selection symbol in red, and the numerical selection symbol in red to the projector 90. The projector 90 projects the symbols to the projection region 330 to form the controlling symbols.

The detecting module 40 detects the image of the projection region 330 to determine whether a controlling symbol is selected. When a controlling symbol corresponding to one of the pattern symbols is selected, the detecting module 40 outputs a detection signal. The timing module 50 records the length of time the controlling symbol has been selected. When the length of time the controlling symbol has been selected is a first preset length of time, such as five seconds, the symbol transmitting module 30 transmits the pattern symbols in gray, the alphabetical selection symbol in gray, and the numerical selection symbol in gray corresponding to the un-selected controlling symbols to the projector 90. The projector 90 projects the symbols in gray to the projection region 330 for replacing the un-selected controlling symbols. As a result, only the selected controlling symbol is red. In other words, when one controlling symbol is selected, other controlling symbols become gray to show that the controlling symbol in red was the one selected. The controlling module 60 receives the detection signal and controls the first camera 70.

Referring to FIG. 3B, when the controlling symbol corresponding to the alphabetical selection symbol “A” is selected, the detecting module 40 outputs a detection signal to the timing module 50. The timing module 50 records the length of time the alphabetical selection symbol “A” has been selected. When the length of time the alphabetical selection symbol “A” has been selected is within the first preset length of time, the detection signal is transmitted to the symbol transmitting module 30. The symbol transmitting module 30 transmits the alphabetical symbols “A” to “Z” in red to the projector 90. The alphabetical symbols “A” to “Z” in red are projected in the projection region 330 as shown in FIG. 3C.

In addition, the symbol transmitting module 30 further transmits the pattern symbols in gray and the numerical selection symbol “9” in gray to the projector 90. The pattern symbols in gray and the numerical selection symbol “9” in gray are projected in the projection region 300 to replace the pattern controlling symbols in red and the numerical selection controlling symbol “9” in red.

Referring to FIG. 3D, the detecting module 40 detects the image of the projection region 330 from the second camera 80. When a controlling symbol “M” is selected, the detecting module 40 outputs a detection signal to the timing module 50. The timing module 50 records the length of time the controlling symbol “M” has been selected. When the length of time the controlling symbol “M” has been selected is a second preset length of time, such as three seconds, the detection signal is transmitted to the controlling module 60. The controlling module 60 directs the first camera 70 to pan the lens of the first camera 70 left. As a result, a duty list 370 may be captured by the first camera 70. The image of the duty list 370 is projected to the projection region 330. In addition, the detection signal is further transmitted to the symbol transmitting module 30. The symbol transmitting module 30 transmits the alphabetical symbols “A” to “L” and “N” to “Z” in gray to the projector 90. The projector 90 projects the alphabetical symbols in gray to the projection region 330 for replacing the controlling symbols “A” to “L” and “N” to “Z” in red. As a result, only the controlling symbol “M” in the projection region 330 is in red to show that the controlling symbol “M” has been selected.

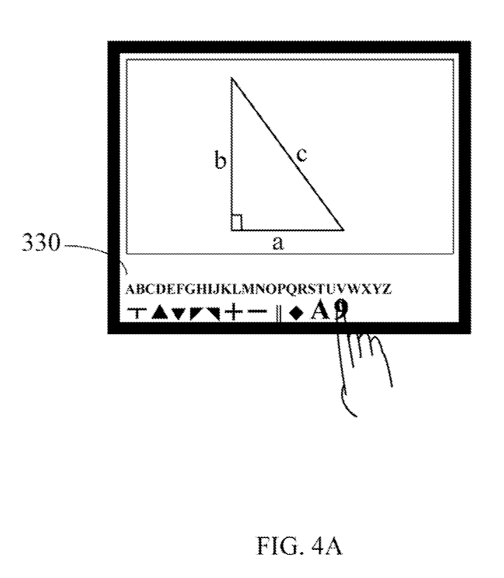

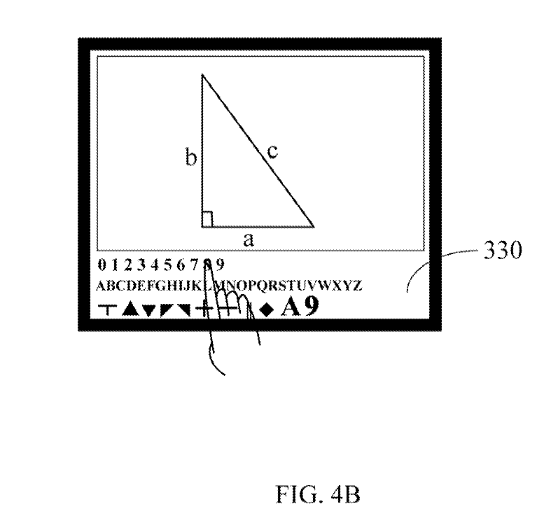

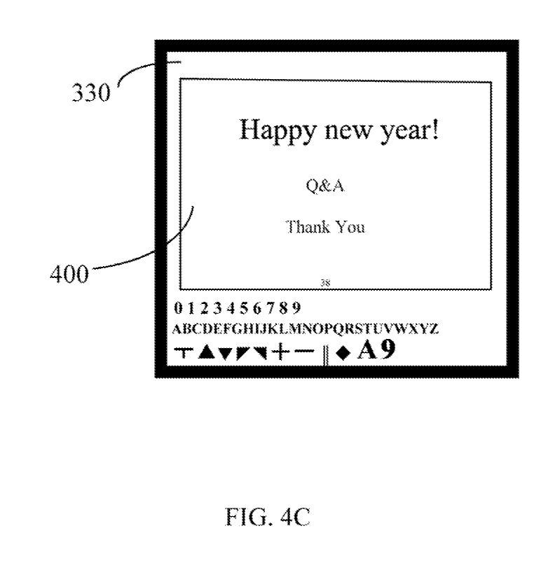

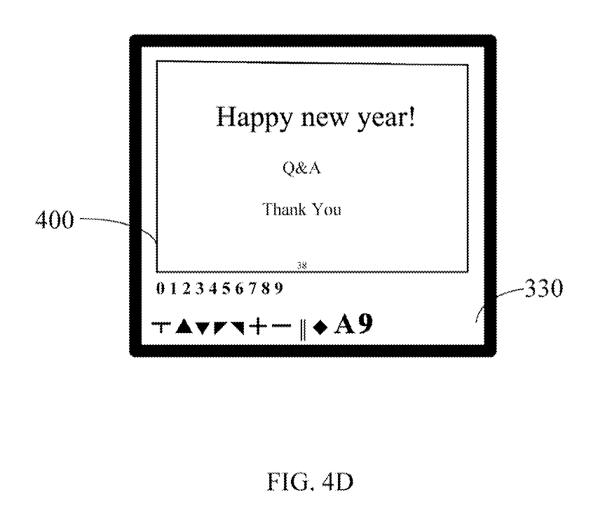

Referring to FIG. 4A, when the controlling symbol “9” in the projection region 330 is selected for the first preset length of time, the detecting module 40 outputs a detection signal. The detection signal is transmitted to the symbol transmitting module 30. The symbol transmitting module 30 transmits the alphabetical symbol “M” in gray to the projector 90. The projector 90 projects the symbol “M” in gray to the projection region 330 to replace the controlling symbol “M” in red. The symbol transmitting module 30 further transmits the numerical symbols “0” to “9” in red to the projector 90. The projector 90 projects the numerical symbols “0” to “9” in red to the projection region 330 as shown in FIG. 4B.

Referring to FIG. 4B, when the controlling symbol “8” has been selected for a third preset length of time, such as two seconds, the detecting module 40 outputs a detection signal. The detection signal is transmitted to the symbol transmitting module 30 and the controlling module 60. The symbol transmitting module 30 transmits the numerical symbols “0” to “7” and “9” in gray to the projector 90 for replacing the controlling symbol “0” to “7” and “9” in red in the projection region 330. The controlling module 60 controls the first camera 70. For example, referring to FIG. 4C, the projector 90 projects a presentation slide 400 from a computer system.

Referring to FIG. 4D, when the controlling symbol “A” is selected again, a detection signal is transmitted to the symbol transmitting module 30. The symbol transmitting module 30 stops transmitting the alphabetical symbols “A” to “Z” to the projector 90. As a result, the controlling symbols “A” to “Z” in the projection region 330 are hidden.

In the embodiment, because the controlling symbols “0” to “9” are above the controlling symbols “A” to “Z”, and the controlling symbol “A” to “Z” are above the controlling symbols “▴”, “▾”, [symbol] “+”, “−”, “♦”, “∥”, and “ [symbol] ”, when the user selects one of the controlling symbols “A” to “Z”, one of the controlling symbols “▴”, “▾”, [symbol] “+”, “−”, “♦”, “∥”, or “ [symbol] ” may be covered. To avoid mistakenly selecting the wrong symbol, the first preset length of time for the first controlling symbols is preset to be longer than the second preset length of time for the third controlling symbols, and the second preset length of time for the third controlling symbols is preset to be longer than the third length of time for the fifth controlling symbols. In this way the user may be able to place their hand over the lower symbols without activating them. In other embodiments, if all the controlling symbols are arranged in a row in the projection region 330, the timing module 50 can be omitted.

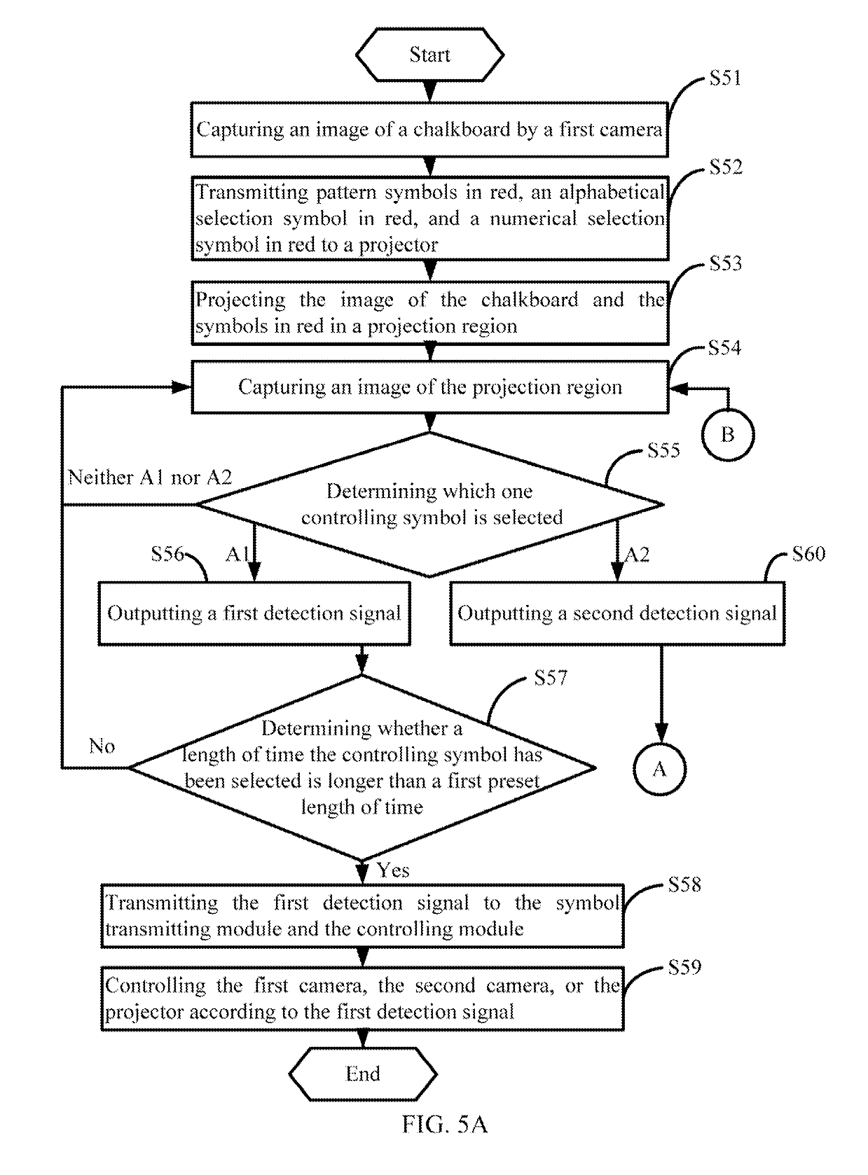

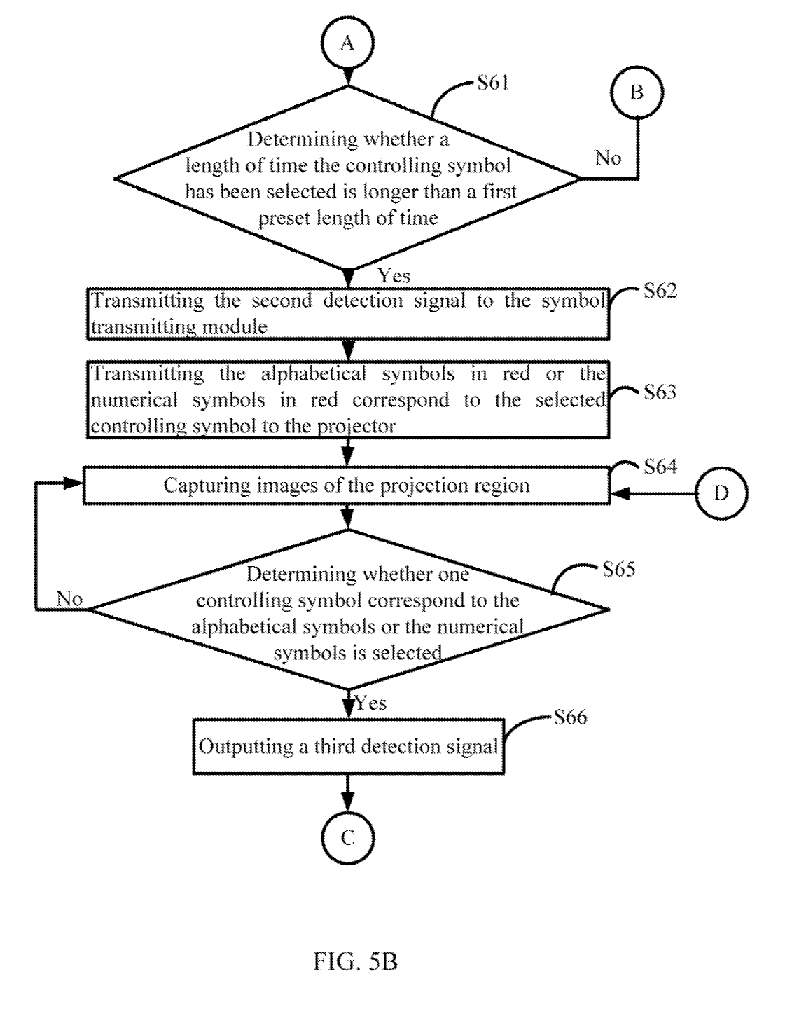

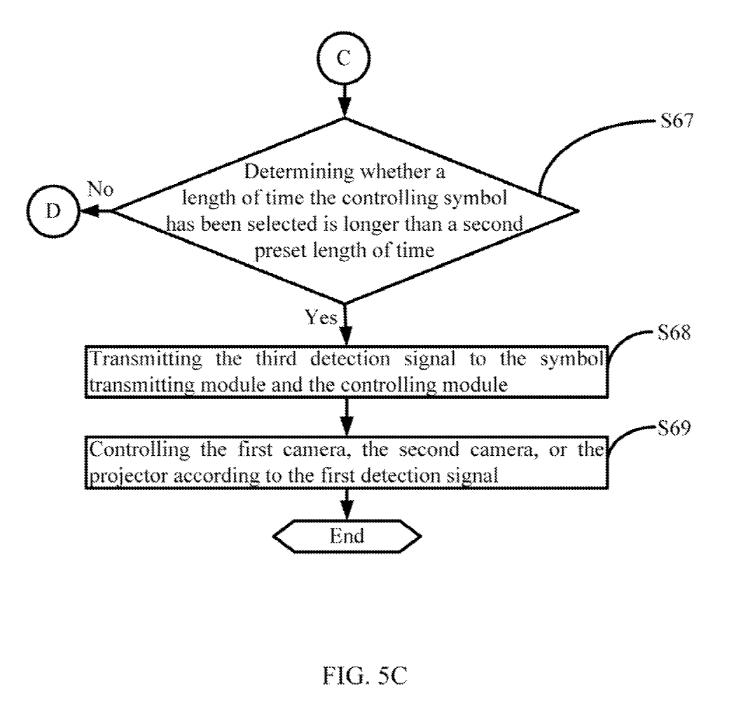

Referring to FIG. 5, an exemplary embodiment of a projection method which includes the following steps.

In step S51, the first camera 70 captures an image of the chalkboard 310.

In step S52, the symbol transmitting module 30 transmits the pattern symbols in red, the alphabetical selection symbol in red, and the numerical selection symbol in red to the projector 90.

In step 53, the projector 90 projects the image of the chalkboard 310 and the symbols in red in the projection region 330. The symbols form the controlling symbols in the projection region 330.

In step S54, the second camera 80 captures an image of the projection region 330.

In step S55, the detecting module 40 detects the image from the second camera 80 to determine which one controlling symbol is selected. Upon the condition that a controlling symbol corresponding to the pattern symbols is selected (marked as A1), the process flows to step S56. Upon the condition that a controlling symbol corresponding to the alphabetical selection symbol or the numerical selection symbol is selected (marked as A2), the process flows to step S60. Upon the condition that neither a controlling symbol corresponds to the pattern symbols nor a controlling symbol corresponding to the alphabetical selection symbol or the numerical selection symbol is selected (neither A1 nor A2), the process returns back to step S54.

In step S56, the detecting module 40 sends a first detection signal according to the selected controlling symbol corresponding to the pattern symbols.

In step S57, the timing module 50 records the length of time the controlling symbol has been selected. Upon the condition that the controlling symbol has been selected for the first preset length of time, the process flows to step S58. Upon the condition the controlling symbol has not been selected for the first preset length of time, the process returns to step S54.

In step S58, the first detection signal is transmitted to the symbol transmitting module 30 and the controlling module 60.

In step S59, the controlling module 60 controls the first camera 70, the second camera 80, or the projector 90 according to the detection signal. The symbol transmitting module 30 transmits the symbols in gray corresponding to the un-selected controlling symbols to the projector 90. As a result, only the selected controlling symbol is red, and other controlling symbols are gray in the projection region 330. The process ends.

In step S60, the detecting module 40 sends a second detection signal according to the selected controlling symbol. The second detection signal is transmitted to the timing module 50.

In step S61, the timing module 50 records the length of time the controlling symbol has been selected. Upon the condition that the controlling symbol has been selected for the first preset length of time, the process flows to step S62. Upon the condition that the controlling symbol has not been selected for the first preset length of time, the process returns to step S54.

In step S62, the second detection signal is transmitted to the symbol transmitting module 30.

In step S63, the symbol transmitting module 30 transmits the alphabetical symbols in red or the numerical symbols in red corresponding to the selected controlling symbol to the projector 90. The projector 90 projects the alphabetical symbols in red or the numerical symbols in red to the projection region 330. In addition, the symbol transmitting module 30 further transmits the pattern symbols in gray and the alphabetical selection symbol in gray or the numerical selection symbol gray corresponding to the un-selected controlling symbol to the projector 90. The projector 90 projects the symbols in gray to the projection region 330 for replacing the corresponding controlling symbols.

In step S64, the second camera 80 captures another image of the projection region 330.

In step S65, the detecting module 40 detects the image from the second camera 80 to determine which one controlling symbol corresponding to the alphabetical symbols or the numerical symbols is selected. Upon the condition that a controlling symbol corresponding to the alphabetical symbols or the numerical symbols is selected, the process flows to step S66. Upon the condition that neither a controlling symbol corresponding to the alphabetical selection symbol nor the numerical selection symbol is not selected, the process flows to step S64.

In step S66, the detecting module 40 outputs a third detection signal according to the selected controlling symbol. The third detection signal is transmitted to the timing module 50.

In step S67, the timing module 50 records the length of time the controlling symbol has been selected, and determines whether the length of time the controlling symbol has been selected is longer than the second preset length of time. Upon the condition that the controlling symbol has been selected for the second preset length of time, the process flows to step S68. Upon the condition that the controlling symbol has not been selected for the second preset length of time, the process returns to step S64.

In step S68, the third detection signal is transmitted to the controlling module 60 and the symbol transmitting module 30.

In step S69, the controlling module 60 controls the first camera 70, the second camera 80, or the projector 90 according to the third detection signal. The symbol transmitting module 30 transmits the symbols in gray corresponding to the un-selected controlling symbols to the projector 90. As a result, only the selected controlling symbol is red, and other controlling symbols are gray in the projection region 330.

In the embodiment, if the controlling symbols are arranged in a row, the steps S57, S61, and S67 can be omitted.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A projection system comprising:
a first camera to capture a first image of an object;
a projector to project the first image of the object to a projection region;
a second camera to capture the projection region to obtain a second image of the projection region;
a processing unit connected between each of the first camera and the second camera, and the projector; and
a storage unit connected to the processing unit and storing a plurality of programs to be executed by the processing unit, wherein the storage unit comprises:
a symbol transmitting module to transmit a selection symbol to the projector, wherein the projector projects the selection symbol in the projection region to form a selection controlling symbol;
a detecting module to detect the second image of the projection region to determine whether the selection controlling symbol is selected, wherein upon the condition that the selection controlling symbol is selected, the detecting module outputs a selection detection signal according to the selected selection controlling symbol, the symbol transmitting module receives the selection detection signal to transmit a plurality of first symbols corresponding to the selected selection controlling symbol to the projector, the projector projects the plurality of first symbols to form a plurality of first controlling symbols in the projection region, wherein the detecting module further detects a third image of the projection region captured by the second camera to determine whether one of the plurality of first controlling symbols is selected, upon the condition that a first controlling symbol is selected, the detecting module outputs a first detection signal according to the selected first controlling symbol; and
a controlling module to control the first camera, the second camera, or the projector according to the first detection signal.

2. The projection system of claim 1, wherein the detecting module further stores a fourth image upon the condition that the selection controlling symbol and the plurality of first controlling symbols are not selected, and after the detecting module receives the third image of the projection region, the detecting module compares the two images to determine whether the selection controlling symbol or one of the first controlling symbols is selected.

3. The projection system of claim 1, wherein the first camera and the second camera are Pan/Tilt/Zoom cameras.

4. The projection system of claim 1, wherein the selection symbol comprises an alphabetical selection symbol and/or a numerical selection symbol, the alphabetical selection symbol corresponds to a plurality of alphabetical symbols, and the numerical selection symbol corresponds to a plurality of numerical symbols.

5. The projection system of claim 1, wherein the storage unit further comprises a timing module, the timing module records a length of time the selected selection controlling symbol has been selected, upon the condition that the selected selection controlling symbol has been selected for a first preset length of time, the detecting module outputs the selection detection signal.

6. The projection system of claim 5, wherein the storage unit further comprises a timing module, the timing module records a length of time the selected first controlling symbol has been selected, upon the condition that the selected first controlling symbol has been selected for a second preset length of time, the detecting module outputs the first detection signal.

7. The projection system of claim 1, wherein the symbol transmitting module further transmits a plurality of second symbols to the projector when the symbol transmitting module transmits the selection symbol to the projector, the detecting module further determines whether one of the plurality of second symbols is selected, upon the condition that a second symbol is selected, the detecting module transmits a second detection signal, the controlling module controls the first camera, the second camera, or the projector according to the second detection signal.

8. The projection system of claim 7, wherein the storage unit further comprises a timing module, the timing module records a length of time the selected second controlling symbol has been selected, upon the condition that the selected second controlling symbol has been selected for a first preset length of time, the detecting module outputs the second detection signal.

9. The projection system of claim 1, wherein after the projector projects the plurality of the first symbols to the projection region, the detecting module further detects another image of the projection region captured by the second camera to determine whether the selection controlling symbol is selected again, upon the condition that the selection controlling symbol is selected again, the projector stops projecting the plurality of the first symbols to the projection region.

10. A projection method comprising:
capturing a first image of an object by a first camera;
projecting the first image of the object and a selection symbol to a projection region by a projector, wherein the selection symbol forms a selection controlling symbols;
capturing a second image of the projection region by a second camera;
detecting the second image of the projection region to determine whether the selection controlling symbol is selected;
outputting a selection detection signal upon the condition that the selection controlling symbols is selected;
transmitting a plurality of first symbols corresponding to the selection symbol to the projector;
projecting the plurality of first symbols in the projection region;
capturing a third image of the projection region by a second camera;
detecting the third image of the projection region to determine whether one of the plurality of first controlling symbol is selected;
outputting a first detection signal upon the condition that one of the plurality of first controlling symbols is selected; and
controlling the first camera, the second camera, or the projector according to the first detection signal.

11. The projection method of claim 10, after the step of “outputting a selection detection signal upon the condition that the selection controlling symbols is selected” further comprising:
recording a length of time the selected selection controlling symbol has been selected, upon the condition that the selected selection controlling symbol has been selected for a first preset length of time, the step of “transmitting a plurality of first symbols corresponding to the selection symbol to the projector” is executed.

12. The projection method of claim 11, after the step of “outputting a first detection signal upon the condition that one of the plurality of first controlling symbols is selected” further comprising:
recording a length of time the selected first controlling symbol has been selected, upon the condition that the selected first controlling symbol has been selected for a second preset length of time, the step of “controlling the first camera, the second camera, or the projector according to the first detection signal” is executed.

13. The projection method of claim 10, wherein the step of “detecting the second image of the projection region to determine whether the selection controlling symbol is selected” comprises:
comparing the second image of the projection region with a fourth image of the projection region upon the condition that the selection controlling symbol is not selected, to determine whether the selection controlling symbol is selected.

14. The projection method of claim 10, wherein the step of “detecting the third image of the projection region to determine whether one of the plurality of first controlling symbol is selected” comprises:
comparing the third image of the projection region with a fourth image of the projection region upon the condition that the plurality of first controlling symbols are not selected, to determine whether one of the plurality of first controlling symbols is selected.

15. A projection system comprising:
a first camera to capture a first image of an object;
a projector to project the first image of the object to a projection region;
a second camera to capture the projection region to obtain a second image of the projection region;
a processing unit connected between each of the first camera and the second camera, and the projector; and
a storage unit connected to the processing unit and storing a plurality of programs to be executed by the processing unit, wherein the storage unit comprises:
a symbol transmitting module to transmit a selection symbol in a first color to the projector, wherein the projector projects the selection symbol in the first color in the projection region to form a selection controlling symbol;
a detecting module to detect the second image of the projection region to determine whether the selection controlling symbol is selected, wherein upon the condition that the selection controlling symbol is selected, the detecting module outputs a selection detection signal, the symbol transmitting module receives the selection detection signal to transmit a plurality of first symbols in the first color corresponding to the operated selection controlling symbol to the projector, the projector projects the plurality of first symbols in the first color to form a plurality of first controlling symbols in the projection region, wherein the detecting module further detects a third image of the projection region captured by the second camera to determine whether one of the plurality of first controlling symbols is selected, upon the condition that a first controlling symbol is selected, the detecting module outputs a first detection signal according to the selected second controlling symbol, the symbol transmitting module further transmits the plurality of first symbols except a first symbol corresponding to the selected first controlling symbol in a second color to the projector to replace the plurality of first controlling symbols in the first color except the selected first controlling symbol; and
a controlling module to control the first camera, the second camera, or the projector according to the first detection signal.
